(19) United States
(12) Patent Application Publication
(10) Pub. No.: US 2006/0141439 A1
(43) Pub. Date: Jun. 29, 2006

(54) Study monitoring system and method using instant communication tools

(75) Inventors: Zechary Chang, Taipei (TW); Yeats Gu, Beijing (CN)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/022,414

(22) Filed: Dec. 23, 2004

(51) Int. Cl. G09B 3/00

(52) U.S. Cl. 434/350

(57) ABSTRACT

A study monitoring system and method using instant communication tools includes a sending setup module to receive a sending type confirmed by a user and store a corresponding account name; a communication linking module to establish a corresponding communication link based on the sending type; an information collecting module to collect a user's study information; a text generating module to edit sending contents and generate a sending web page based on the studying information; and an information sending module to send the sending web page to an instant communication tool and enable study monitors to know instantly the software user's actual study habits.

### FIELD OF THE INVENTION

The invention relates to a monitoring system and method, and particularly to a system and method to monitor study through instant communication tools.

### BACKGROUND OF THE INVENTION

With information systems becoming more comprehensive and computer technology advancing continuously, a great deal of computer instruction software has been developed and introduced on the market. Instruction software aims to enable learning and training through the computer. However, knowledge has to be obtained through gradual and continuous accumulation, and persistent devotion and effort. To students who do not have enough self-discipline, how to monitor their study progress is an issue that very much concerns teachers and parents.

In general, monitoring a student's progress by teachers often is limited to the classroom. After the class and outside the classroom, urging students to devote more time and effort to study is mostly done by the students' parents. It is difficult for teachers to be fully aware of students' extracurricular activities. While many parents try to accompany their children in studying, they mostly aim to understand their children's interests. Some parents try to find out the problems their children encounter, and to provide help if possible. But many parents have their own jobs to worry about, and cannot allocate much time to watch their children's study. In some cases, parent's monitoring is even counter-effective due to young people's offensive and rebellious attitude. Both the students and parents could become frustrated, which affects study results. Moreover, these days a proliferation of game ware is available in computers and networks, so it is very difficult for the parents to constantly watch whether their children are studying or playing games on the computer.

Now there is instruction software that can record computer usage and transmit this information to the network server. There is also software designed to be fun and interesting, to enhance student's study motivation and persistency. Parents can also check their children's study habits through the records stored in the computer or web sites. But parents and teachers have to take the initiative to access these records, which is often not done constantly. Hence even if the instruction software is good, the result is not desirable if the teachers or parents do not access those records regularly.

Thus there is a need to provide an exchange platform to enable teachers and parents to have a clear understanding of students' study habits and to improve monitoring and coaching effectiveness of students' study.

### SUMMARY OF THE INVENTION

In view of the aforesaid disadvantages, the primary object of the invention is to provide a study monitoring system and method that employs instant communication tools to enable monitors to have a clear understanding of software studying records of a software user so that the monitors can be instantly informed of the user's actual study habits.

In order to achieve the foregoing object, the study monitoring system according to the invention aims to send the student's instruction software use conditions and study information to an instant communication tool. It includes a sending setup module to receive sending objects, input by a user, and store a corresponding account name; a communication linking module to establish a corresponding connection link based on the sending types; an information collecting module to collect user's instruction software use conditions and study habits; a text generating module to edit sending content and generate a sending web page based on the studying information; and an information sending module to deliver the sending web page to an address corresponding to the account name based on a sending condition.

The invention also provides a monitoring method to send the user's use conditions of the instruction software and study information to an instant communication tool. First, receive the sending type sent by a user based on the sending object, and store a corresponding account name; next, establish a corresponding connection link according to the sending type to collect the user's study information; generate a sending web page according to the study information; and send the sending web page to the instant communication tool according to the sending condition.

The study monitoring system and method according to the invention is an important tool for supervising and monitoring students. It provides an interactive platform among teachers, parents and students. The teachers and parents can readily obtain the use conditions of the software users through the instant communication tool. Student's actual study progress is recorded instantly, including study time, finished exercise numbers, test ratings, etc. Teachers and parents can obtain students' actual study conditions constantly, and perform supervision and monitoring as desired.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a module structure of the study monitoring system using instant communication tools of the invention.

FIG. 2 is a process flow chart of the study monitoring method using instant communication tools of the invention.

FIGS. 3, 4 and 5 are schematic views of embodiments of user interfaces of the invention.

FIG. 6 is a schematic view of the structure of a first embodiment of the invention that uses a PC as the instant communication tool for monitoring.

FIG. 7 is a schematic view of the structure of a second embodiment of the invention that uses a mobile phone to send short messages for monitoring.

FIGS. 8 through 11 are schematic views of information text embodiments according to the invention.

### DESCRIPTION OF THE PREFERRED EMBODIMENTS

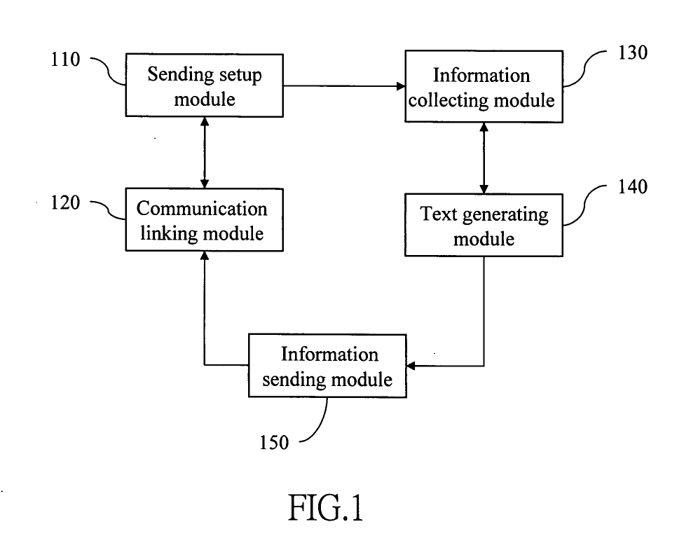

The study monitoring system and method using instant communication tools according to the invention aims to send instruction software use conditions and study information of students to instant communication tools. Refer to FIG. 1 for a block diagram of a module structure of the study monitoring system of the invention. It includes a sending setup module 110 to set up users; a communication linking module 120 connecting to the sending setup module 110; an information collecting module 130 to collect the user's study information of the instruction software; a text generating module 140 to receive the user's study information from the information collecting module 130 and generate a corresponding sending web page; and an information sending module 150 to send the sending web page to a corresponding address. The instant communication tools may be remote mobile phones, personal digital assistants (PDA), pagers, or instant communication tools in personal computers such as Microsoft software or a locally developed program application.

The sending setup module 110 aims to receive sending objects input by a user, and store a corresponding account name. The user can select a sending message type that includes a handset short message, electronic mail, paging information, instant message or the like. If the handset short message is selected, the handset number to receive the sending object has to be input. For sending an e-mail, the e-mail address must be entered. If paging information is selected, the paging number has to be provided. For sending an instant message, the corresponding account number to receive the message should be provided. The sending setup module stores these account numbers for sending the corresponding objects.

The communication linking module 120 aims to establish a corresponding communication link according to the sending types, such as establishing and activating an e-mail sending program for sending e-mails, or establishing a connection with a short message sending center for sending handset short messages.

The information collecting module 130 aims to collect a user's instruction software use conditions and study information which include course progress, accumulated study time, finished exercise numbers, test rating, etc. For the instruction software operating in a network environment, software use conditions and study information mostly are stored in the network server. Even if users do not start machine operation, the information collecting module still can logon on and access this information from the network server.

The text generating module 140 aims to edit sending contents and generate sending web pages according to the study information, such as editing an automatic mail delivery schedule page if e-mail is adopted.

The information sending module 150 aims to deliver the sending web page to a corresponding account name address according to a sending condition. It has a sending control unit to instantly determine the sending condition. If the sending condition is met, the sending web page is sent to the corresponding account. The sending condition may be set by users, such as fixed time sending, periodic sending, or selected time sending based on study stages.

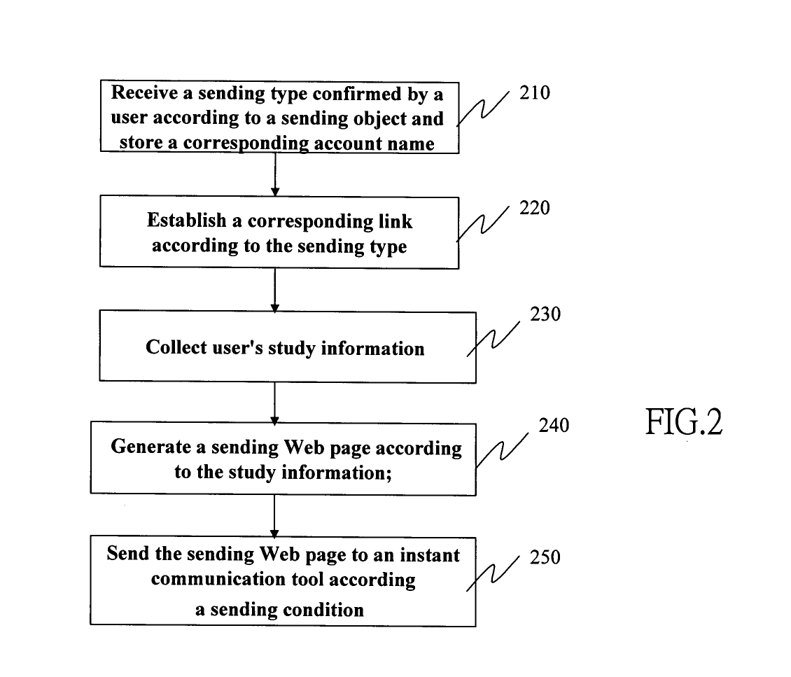

Refer to FIG. 2 for the process flow of the study monitoring method of the invention. First, receive the sending type sent by a user based on the sending object, and store a corresponding account name (step 210); next, establish a corresponding connection link according to the sending type with a corresponding instant communication tool (step 220); collect user's study information including course progress, accumulated study time, finished exercise numbers, test rating, etc (step 230); generate a sending web page according to the study information and determine the sending condition, which may be set by the user and may include fixed time sending, periodic sending, or selected time sending based on study stages (step 240). If the condition permits, send the sending web page to the instant communication tool (step 250), which may be a mobile phone, PDA, pager, or MSN Messenger ICQ on a personal computer.

More details of the invention are elaborated below based on e-mail and handset short messages as examples to monitor remote studying.

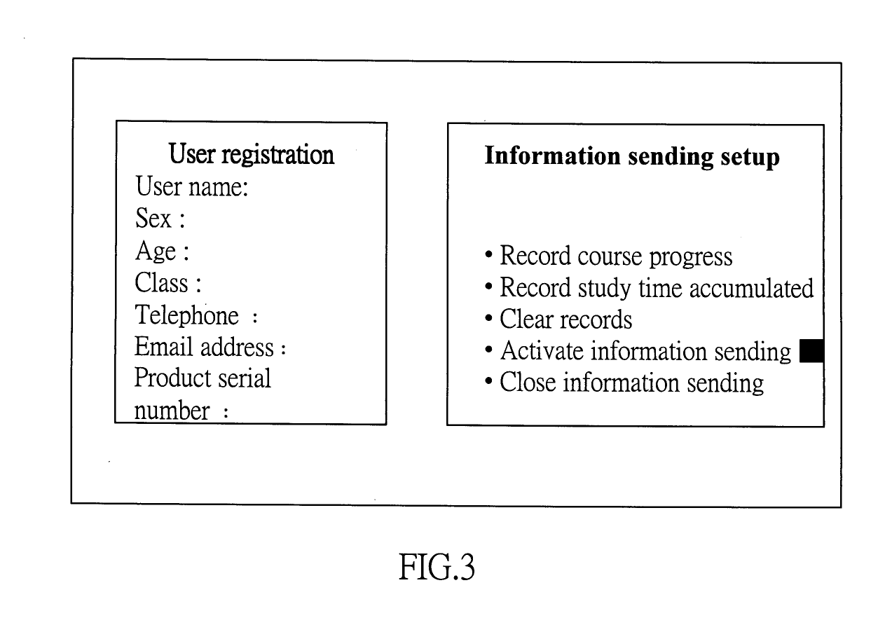

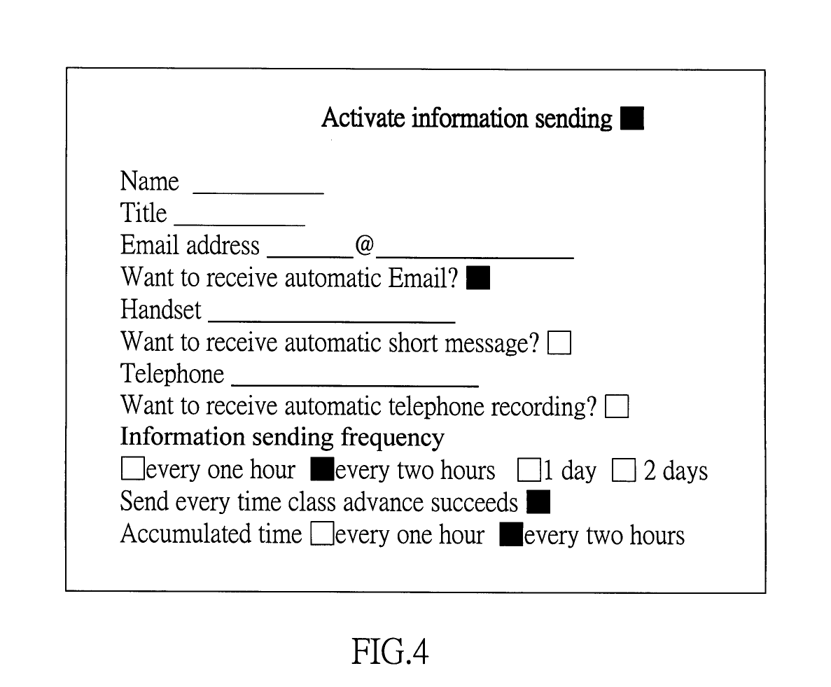

To adopt the study monitoring method of the invention, before the system is implemented, the operation environment has to be set up, and network communication links and short message transmission protocols with the short message center or SP must be established. First, activate the study information sending function as shown in FIG. 3. FIG. 3 illustrates an embodiment of information sending setup interface. When a software user registers, s/he has to provide general user information and selected study information required for information sending setup, such as selecting “record course progress,” “record study accumulated time,” or “clear records,” etc. If the user selects the “activate information sending” key, the interface shown in FIG. 4 is displayed. This interface is used to set up e-mail address, handset number, and the like, and also to set up information sending conditions, such as sending every hour or two hours after the user has registered. The following is an example of the communication format:

User_Name: Alex

Sending Object: User_Parent Father

Sending Email address: name@webname.com

Sending SMS address: XXXX

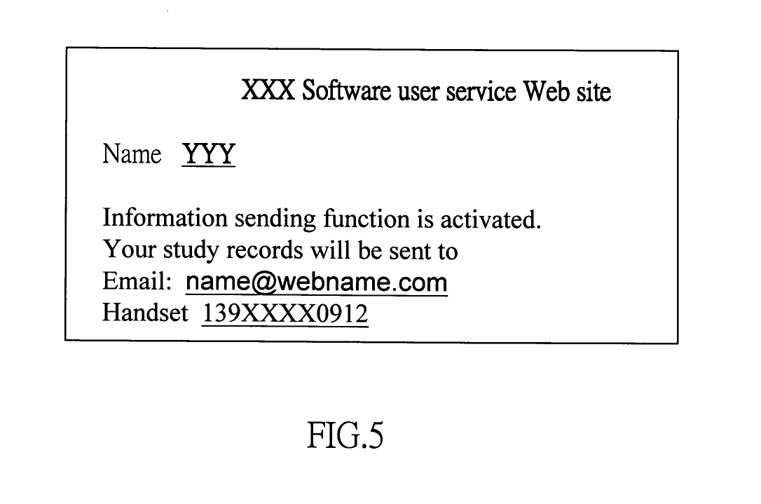

After the system has finished the aforesaid study information sending function setup, when the user uses the instruction software, s/he is automatically logged on to an instruction software user service web site interface, as shown in FIG. 5. The system collects the user's study information of the instruction software in the web site as follows:

Study course: User_Module English conversation

Last accumulated rating: User_Score:

Used time: User_Time Hours Minutes

Stage Achievement: User_Eval Marks

User_Schedule: Second class, third hour

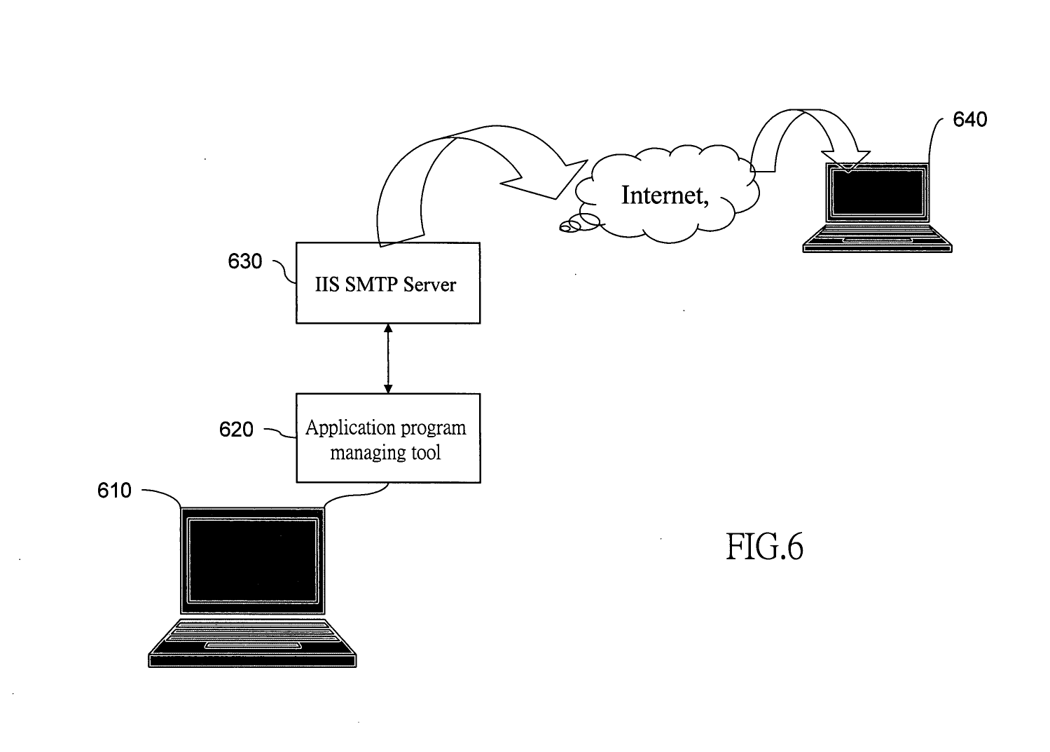

If the user selects Email to send the study information, the sending structure is shown in FIG. 6. The user's computer is linked to an application program management tool. After the user's study information has been collected, the system edits an automatic mail sending schedule web page, and reads the user's ID preset sending information web page and sending condition to generate a preset sending information text. Meanwhile, the system instantly determines the sending condition. If the conditions are met, it sends the mail to a corresponding monitor user through an IIS SMTO server. The monitor computer can receive the corresponding Email according to the following process:

readdata read User_ID

reardata read the sending information block to be sent

judge_conditions determine the sending condition

text_gendata generate the information text to be sent

send_emaildata_address data send the mail to the receiving mailbox corresponding to the User_ID

confirm_emaildatadata Note record of mail receiving confirmation

count++data_count effective counting number of sending mail to the receiving mailbox corresponding to the User_ID

The generated text is as follows:

User_Parent of User_name please receive the message <BR><BR> Dear Sir: <BR><BR> User_name is taking computer instruction User-Module English conversation. Last accumulated rating is: User_Score; Use time: User_Time; Stage achievement: User_Eval. Now user is studying second class, third hour; please pay attention to <BR><BR>. English express customer service department, Current_Date.

The web page is stored in the IIS information management database. The mail is automatically sent when SMTP service is activated.

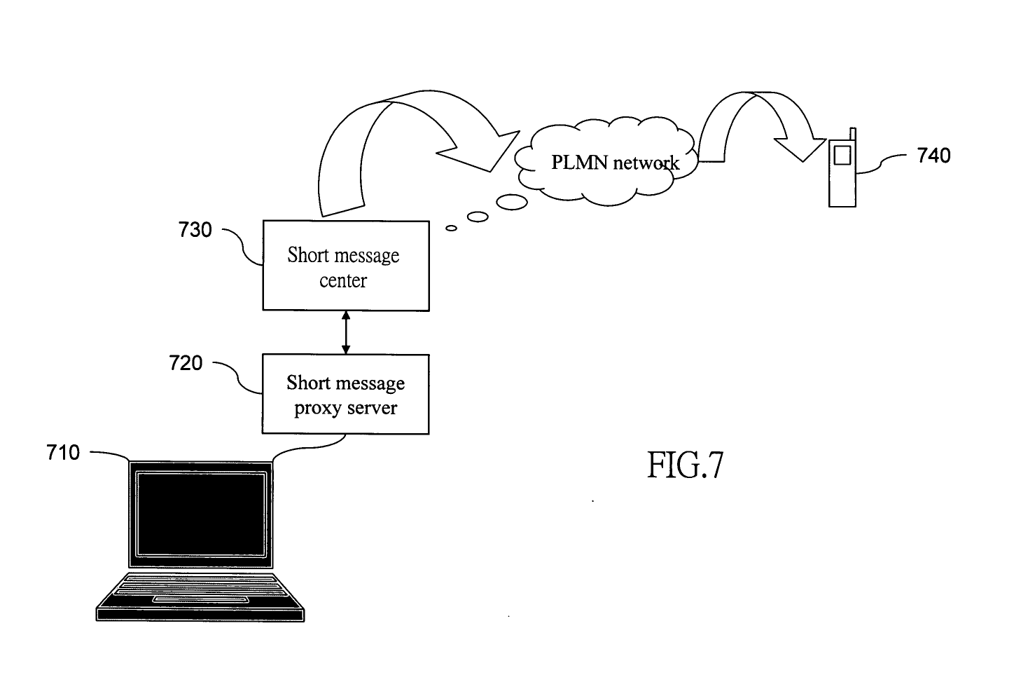

Refer to FIG. 7 for the system structure of another embodiment of the invention that uses a handset to send short messages of study information. The embodiment uploads handset user data through SMS (Short message service) to a user service web site and adopts a cooperative operation mode with a mobile data business service provider and telecommunication operator. The user's computer is linked to a short message proxy server to send the short message text to the short message center (SMC). The text is then sent to a monitor's handset. The connection and transmission between the SMC and the monitor's handset is established through a PLMN network link according to related protocols (such as GSM, SMPP protocols, etc.). The communication protocol between ESME and SMSC generally adopts TCP/IP. The upper layer protocol may be SMPP or other expansion protocols.

According to the short message business function stipulated in the protocols, an API user interface has to register in the information platform short message center service end. After a user's initialized interface has succeeded, the user has to register at the service end. System ID is the account number and Password is the password of the account number to receive Deliver messages sent to the interface from the short message center or short message gate.

When there is no need to receive the short messages and a disconnect notice is sent by ISMG, the user can use a send/inquiry/delete short message through SM Proxy to log off from the ISMG.

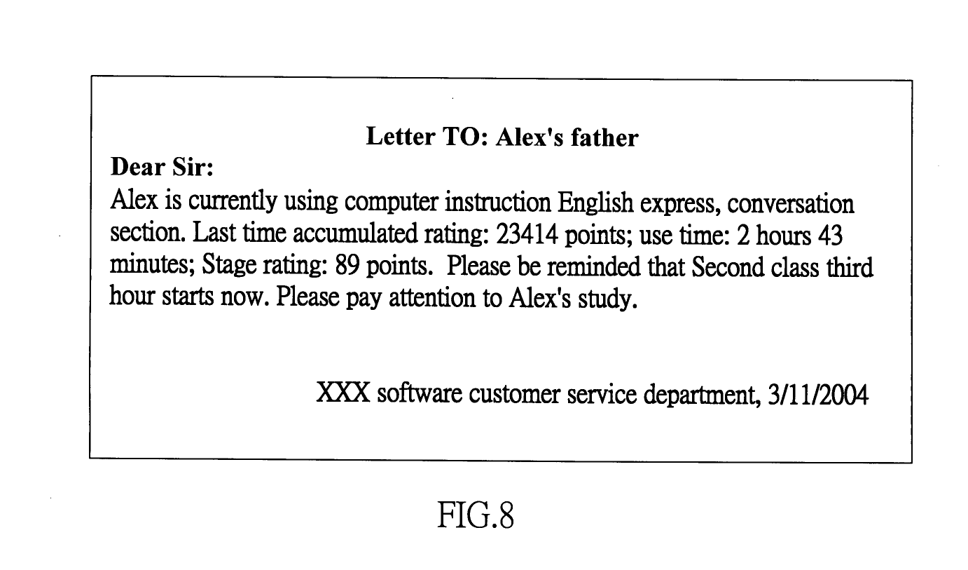

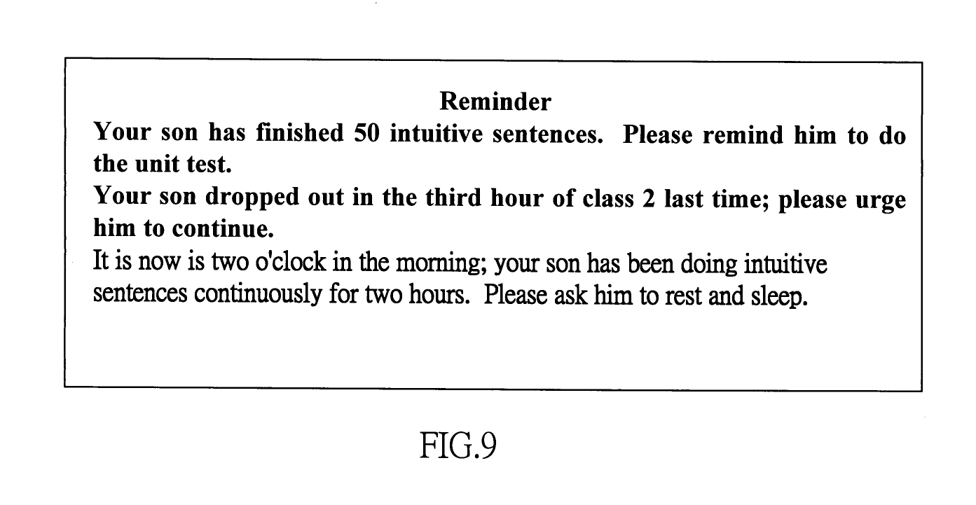

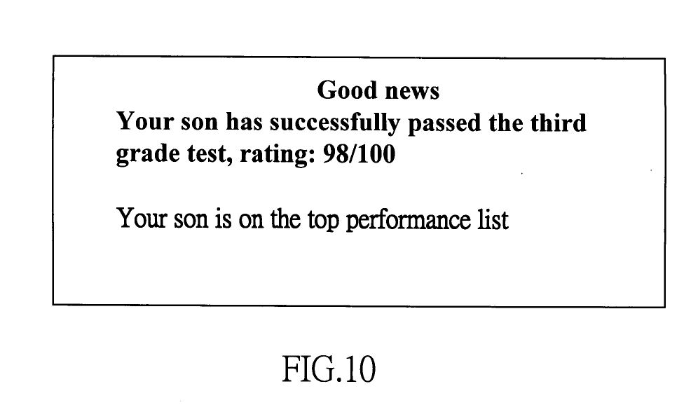

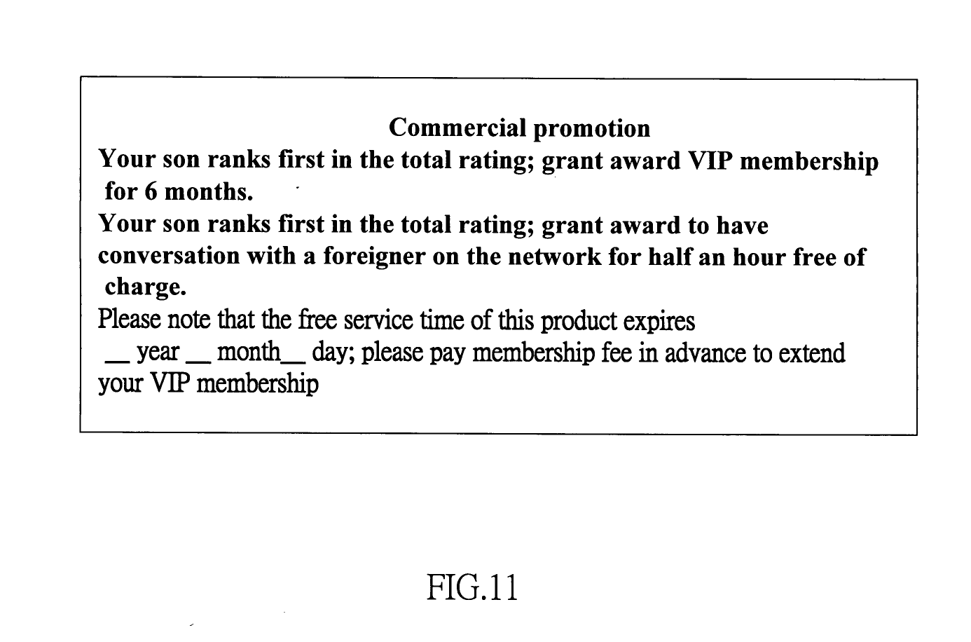

Refer to FIGS. 8 through 11 for web pages to send Email and handset short messages. These may include mail, reminders, good news, commercial promotions, etc.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments □which do not depart from the spirit and scope of the invention.

What is claimed is:

1. A study monitoring system using instant communication tools to send a user's conditions of using an instruction software and study information to an instant communication tool, comprising:
a sending setup module to receive an information sending type input by the user, and store an account name of the sending type;
a communication linking module to establish a corresponding communication link according to the sending type;
an information collecting module to collect the user's conditions of using the instruction software and the study information;
a text generating module to edit sending information and generate a sending web page according to the study information; and
an information sending module to send the sending web page to an address corresponding to the account name according to a sending condition.

2. The study monitoring system of claim 1, wherein the study information includes course progress, accumulated study time, finished exercise number, and test rating.

3. The study monitoring system of claim 1, wherein the instant communication tool includes a mobile phone, a personal digital assistant, a pager and an instant communication tool in a personal computer.

4. The study monitoring system of claim 1, wherein the sending type includes a handset short message, an electronic mail, a paging message and an instant message.

5. The study monitoring system of claim 1, wherein the information sending module includes a sending control unit to determine the sending condition and control information sending of the information sending module based on the determination result.

6. The study monitoring system of claim 1, wherein the sending condition includes a fixed time sending, a periodical sending and a selected time sending according to instruction stages.

7. A study monitoring method using instant communication tools to send a user's conditions of using an instruction software and study information to an instant communication tool, comprising the steps of:
receiving a sending type confirmed by the user according to a sending object and storing a corresponding account name;
establishing a corresponding link according to the sending type;
collecting the user's study information;
generating a sending web page according to the study information; and
sending the sending web page to the instant communication tool according a sending condition.

8. The study monitoring method of claim 7, wherein the study information includes course progress, accumulated study time, finished exercise number, and test rating.

9. The study monitoring method of claim 7, wherein the instant communication tool includes a mobile phone, a personal digital assistant, a pager and an instant communication tool of a personal computer.

10. The study monitoring method of claim 7, wherein the sending type includes a handset short message, an electronic mail, a paging message and an instant message.

11. The study monitoring method of claim 7, wherein the sending condition includes a fixed time sending, a periodical sending and a selected time sending according to instruction stages.

12. The study monitoring method of claim 7, wherein the establishing a corresponding link according to the sending type establishes and activates an electronic mail sending program.

13. The study monitoring method of claim 7, wherein the establishing a corresponding link according to the sending type establishes a connection with a short message sending center (SMC).

14. The study monitoring method of claim 7, wherein the establishing a corresponding link according to the sending type establishes a connection with an instant communication tool of a personal computer.
